(19) United States
(12) Patent Application Publication
(10) Pub. No.: US 2009/0199110 A1
(43) Pub. Date: Aug. 6, 2009

(54) APPARATUS AND METHOD FOR TRANSMITTING ANIMATION-BASED MESSAGE

(75) Inventors: Yeo-jin KIM, Suwon-si (KR); Sang-gyoo SIM, Seoul (KR); Kyung-im JUNG, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/366,063

(22) Filed: Feb. 5, 2009

(30) Foreign Application Priority Data
Feb. 5, 2008 (KR) 10-2008-0011912

(51) Int. Cl. G06F 3/048

(52) U.S. Cl. 715/752

(57) ABSTRACT

Provided are an apparatus and method for transmitting an animation-based message. The apparatus includes a user interface provider which provides a user interface that allows a user to input message information including script-based animation information, a message generator which generates a message based on the input information, and a message transmitter which transmits the generated message.

### CROSS-REFERENCE TO RELATED APPLICATION

This application claims priority from Korean Patent Application No. 10-2008-0011912 filed on Feb. 5, 2008 in the Korean Intellectual Property Office, the disclosure of which is incorporated herein by reference in its entirety.

### BACKGROUND OF THE INVENTION

1. Field of the Invention

Apparatuses and methods consistent with the present invention relate to transmitting an animation-based message, and more particularly, to transmitting an animation-based message that reflects the individual preference of a user.

2. Description of the Related Art

User-generated content is becoming increasingly prevalent in recent times and has started to play an important role in the overall content market. With the development of multimedia content technology, users that previously generated static content, such as text and pictures, are showing a high interest in video. Further, development is taking place in such a manner that even general users are able to capture and edit video, and use shared technology.

Accordingly, even when users send and receive messages, other than text-only messages, through mobile devices such as cell phones, messages are attached with multimedia files before transmission, or interfacing with mobile devices takes places through 2D/3D avatars.

In the case of MMS (Multimedia Message Service), in which multimedia files are attached to text messages, the sender directly generates text through a mobile device in accordance with the MMS message standard, and attaches multimedia files such as images and video before transmitting the message to the mobile device of a receiver.

Further, in the case where the mobile device supports 3D avatars, the avatars are not characters that act on the behalf of users that transmit messages, but function to provide a dynamic interface between the receiver and the mobile device.

In the case of MMS or services using avatars, compared to the existing message transmission based on text, an advanced message service is provided. However, with MMS, a function which allows users to directly generate and transmit animation is not supported, and the avatars are used only to provide an interface for the users on the receiving side, and a method by which the users on the sending side directly present animation.

Accordingly, there is a need for a capability which allows message transmission in which an animation function is added to messages according to the individual preference of users on the sending side and in which the added animation function can act on the behalf of the users on the sending side.

Korean Unexamined Patent 2006-0034824 discloses a method in which a script for executing specific content according to user-designated contents is downloaded through a designated path, and a macro function for automatically executing the corresponding script is realized on a mobile terminal. However, Korean Unexamined Patent 2006-0034824 fails to disclose a method by which users of a sending side add to messages an animation function according to the individual preference of the users, and transmit such messages.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above. Aspects of the present invention provide an apparatus and method for transmitting an animation-based message, in which a message may be generated and transmitted by a user that includes text, animation information, and copyright information according to the individual preference of the user. Aspects of the present invention also provide an apparatus and method for transmitting an animation-based message, in which earnings may be distributed to a user according to copyright information of the user.

According to an aspect of the present invention, there is provided an apparatus for transmitting an animation-based message, the apparatus including: a user interface provider which provides a user interface that allows a user to input message information including script-based animation information; a message generator which generates a message based on the input information; and a message transmitter which transmits the generated message.

According to another aspect of the present invention, there is provided an apparatus for transmitting an animation-based message, the apparatus including: a message transmitting device which transmits a message including script-based animation information; and a message relay device which provides animation information included in the message to the message transmitting device.

According to another aspect of the present invention, there is provided a method of transmitting an animation-based message, the method including: providing a user interface that allows a user to input message information including script-based animation information; generating a message based on the input information; and transmitting the generated message.

According to another aspect of the present invention, there is provided a method of transmitting an animation-based message, the method including: transmitting a message including script-based animation information; and providing animation information included in the message to a device transmitting the message.

### BRIEF DESCRIPTION OF THE DRAWINGS

The above and other aspects and features of the present invention will become more apparent by describing in detail exemplary embodiments thereof with reference to the attached drawings, in which:

FIG. 1 is a block diagram of an apparatus for transmitting an animation-based message according to an exemplary embodiment of the present invention;

FIG. 2 is a schematic diagram of a user interface according to an exemplary embodiment of the present invention;

FIG. 3 is a schematic diagram of an action menu, according to an exemplary embodiment of the present invention;

FIG. 4 is a schematic diagram of a second region of a user interface, according to an exemplary embodiment of the present invention;

FIG. 5 is a schematic diagram of a high-level menu, according to an exemplary embodiment of the present invention;

FIG. 6 is a flowchart of a method of transmitting an animation-based message, according to an exemplary embodiment of the present invention;

FIG. 7 is a flowchart of a method of transmitting a message based on downloaded animation information, according to an exemplary embodiment of the present invention;

FIG. 8 is a flowchart of a method of receiving an animation-based message, according to an exemplary embodiment of the present invention; and

FIGS. 9 and 10 are schematic diagrams of messages reproduced on a message receiving device, according to an exemplary embodiment of the present invention.

### DETAILED DESCRIPTION OF EXEMPLARY EMBODIMENTS

The various aspects and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the present invention to those skilled in the art, and the present invention is defined by the appended claims. Like reference numerals refer to like elements throughout the specification.

The present invention will hereinafter be described in detail with reference to the accompanying drawings.

An apparatus and method for transmitting an animation-based message according to an embodiment of the present invention are described hereinafter with reference to the block diagrams and flowchart illustrations. It will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which comprises one or more executable instructions for implementing the specified logical function(s). It should also be noted that in some alternative implementations, the functions noted in the blocks may occur out of the order shown. For example, two blocks shown in succession may in fact be executed substantially concurrently or the blocks may sometimes be executed in the reverse order, depending upon the functionality involved.

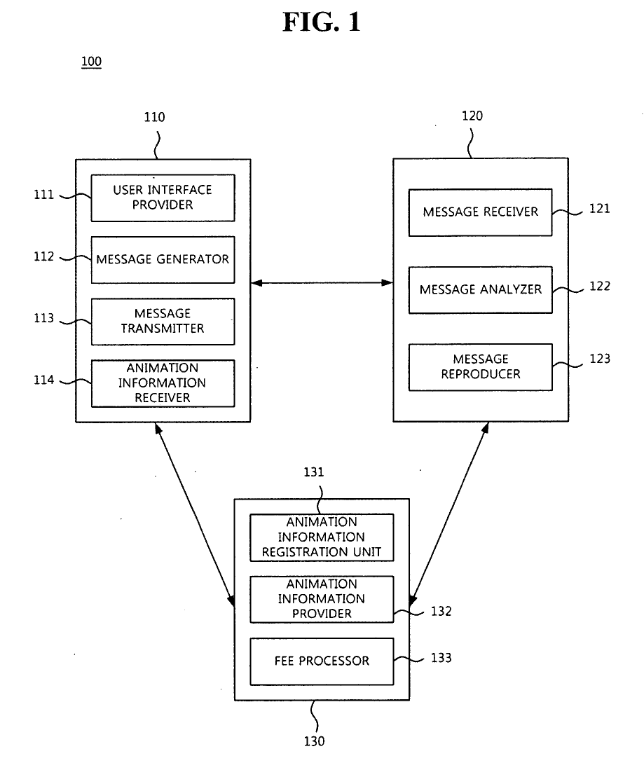

FIG. 1 is a block diagram of an apparatus transmitting an animation-based message according to an embodiment of the present invention.

Referring to FIG. 1, an apparatus 100 for transmitting an animation-based message according to an embodiment of the present invention includes a message transmitting device 110 which transmits a message including at least one of text, animation information, and copyright information, and a message receiving device 120 which receives the message transmitted by the message transmitting device 110 and outputs the message. In the current embodiment of the present invention, each of the message transmitting device 110 and the message receiving device 120 may be a device capable of sending and receiving messages through wireless communications, such as a mobile phone, a PMP (portable multimedia player), a UMPC (ultra-mobile portable computer), etc. The protocol and language used when sending and receiving messages may widely vary as long as they are supported by both the message transmitting device 110 and the message receiving device 120. Further, in the current embodiment of the present invention, an example is described in which the message transmitting device 110 and the message receiving device 120 are able to send and receive 2D/3D animation information together with text. An example is given by which the message transmitting device 110 and the message receiving device 120 are subscribed to an animation message service for sending and receiving messages that include animation information, and have been installed with an application for using such an animation message service. When installing the application, basic animation information (for example, avatars, objects, avatar and object movements, camera compositions, illumination intensities, background sounds, etc.) may also be installed. Further, in the current embodiment of the present invention, the message transmitting device 110 and the message receiving device 120 are described as respectively transmitting and receiving messages. However, such differentiation is only for purposes of illustration and it is possible for each of the message transmitting device 110 and the message receiving device 120 to have both transmitting and receiving capabilities, in which case each of the message transmitting device 110 and the message receiving device 120 has all elements required for transmission and reception as described below.

Moreover, in the current embodiment of the present invention, an example is described in which the message transmitting device 110 and the message receiving device 120 send and receive messages including script-based animation information. Unlike typical video in which the entire video is recorded, messages including script-based animation information are in a text format and are rendered in real-time when reproduced such that the script is easily edited and compiled to make a new animation. Accordingly, through such scripts, users are not only able to easily perform editing, but reuse is made easy for the users.

The message transmitting device 110 includes a user interface provider 111 which provides a user interface that allows the user to input at least one of text, animation information, and copyright information, a message generator 112 which generates messages based on information input through the user interface provider 111, and a message transmitter 113 which transmits the generated messages to the message receiving device 120. In the current embodiment of the present invention described below, an example is described in which the user inputs text and animation information, and selectively inputs copyright information.

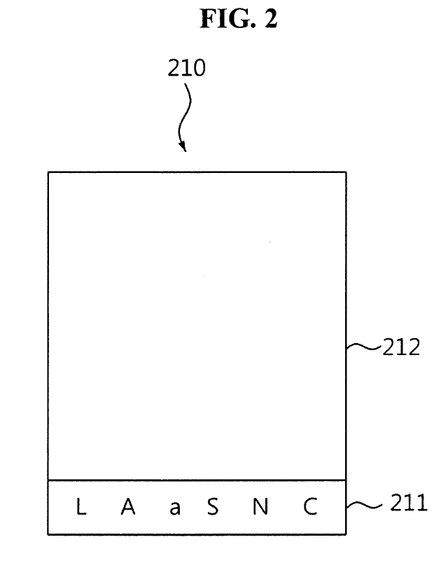

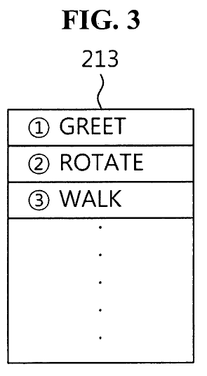

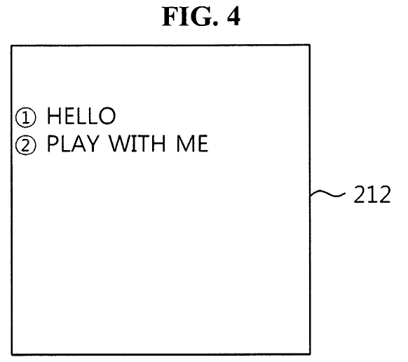

The user interface provider 111, with reference to FIG. 2, provides a user interface 210 including a first region 211 which allows the user to select an information input mode for inputting text, animation information, and copyright information, and a second region 212 for displaying the input information. The user interface 210 of FIG. 2 may be output on a screen of a device, such as a mobile phone, PMP, UMPC, etc. As an example, the letters appearing in the first region 211 may have the following meanings: “L” may refer to selection of a specific language mode, “A” may refer to an uppercase input mode, “a” may refer to a lowercase input mode, “S” may refer to a special character input mode, “N” may refer to an animation information input mode, and “C” may refer to a copyright information input mode. Accordingly, the user selects a corresponding input mode in the first region 211 and inputs text, animation information, and copyright information. For example, if the user selects “N” in the first region 211, the user interface provider 111 provides an action menu 213 as shown in FIG. 3. The action menu 213 allows the user to select an action of animation. After the user selects a desired action through the action menu 213, the user may select “L” and input corresponding text in a specific language. (As an example, English may be the default language, and the corresponding text may be input in a particular language other than English when “L” is selected.) To provide a more concrete example, after selecting “Greet” in the action menu 213, the user inputs “Hello,” then after selecting “Rotate” in the action menu 213, the user inputs “Play with me.” The user interface provider 111 displays this input by the user in the second region 212, as shown in FIG. 4, such that the user can verify what he or she has input. As shown in FIG. 4, an index for each item in the action menu 213 (e.g., \textcircled{1} and \textcircled{2}) may be displayed in the second region 212 of FIG. 4. If the user desires to establish a copyright with respect to animation information selected by him or her, the user selects “C” in the first region 211 and establishes his or her copyright, for example, the user's mobile phone number, whether or not redistribution is possible, whether or not changes are possible, whether or not a fee is required, etc. If the user selects that a fee is required, when another user utilizes the animation information of the initial user, the other user can use the animation information after paying a predetermined sum. In this case, the initial user may be allocated a predetermined percentage of the sum paid by the other user.

The user interface 210 of FIG. 2 is provided only for illustrative purposes to aid in understanding the present invention, and the present invention is not limited in this regard. The user interface 210 may be varied in many ways as long as the user is provided with a function for generating an animation.

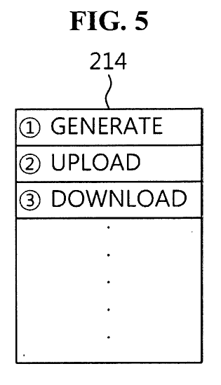

Animation information input that takes place through the action menu 213 may be that in which basic actions that are supported are combined to generate new actions, and users that desire more precise action control may change various parameters in a script of basic actions to thereby generate actions. For this purpose, the user interface provider 111, with reference to FIG. 5, may provide a high-level menu 214 that allows the user to control a precise action through a “Generate” item, allows the user to upload animation information that he or she generated to a device for sharing animation information through an “Upload” item, and allows the user to download animation information generated by another user through a “Download” item.

Further, although not shown in FIGS. 2 through 5, the user interface provider 111 may provide a menu for selecting a character (for example, an avatar) for performing the corresponding actions. Moreover, the action selected through FIG. 3, may be stored internally as a corresponding animation structural element, that is, a specific animation ID (hereinafter “AID”). For example, a specific AID may be given to each predetermined action with respect to a predetermined avatar. In the current embodiment of the present invention, although an AID is described as being given to each action of an avatar, the present invention is not limited in this respect and, in addition to assignment to each avatar action, an AID may be given to an action of an object, a camera composition frequently used, a specific production technique, or a single animation that combines these parameters.

The user may input animation information in this manner through the user interface provider 111. Alternatively, the user may download animation information generated by another user. The apparatus 100 for the transmission of an animation-based message according to an embodiment of the present invention may further include a message relay device 130 for providing animation information generated by others. The message transmitting device 110 may further include an animation information receiver 114 for downloading animation information made by others. The message relay device 130 may have a function for supporting an animation function when at least one of the message transmitting device 110 and the message receiving device 120 does not support an animation function. This will be described below.

Downloaded animation information may include copyright information as described above. To provide an example, when copyright information of received animation information may not be reproduced, may not be changed, and is free, and when the user intends to transmit a message using the received animation information, the message generator 112 displays a warning message that reproduction is not permitted, and similarly, when the user intends that the received animation information not be changed, the message generator 112 displays a warning message that changes are not permitted. When the animation information that is fee-based, a predetermined sum must be paid before downloading is possible. The user is able to input text as described above into the downloaded animation information.

In addition, as a method of sharing or reusing animation information among users, animation information may be directly transmitted from the message transmitting device 110 to the message receiving device 120 without having to register at the message relay device 130, such that the message receiving device 120 may extract the animation information and reuse the same.

The message generator 112 generates a message based on information input by the user through the user interface 210 provided by the user interface provider 111 or based on downloaded animation information. In greater detail, the message generator 112 has a function that is able to convert information input through the user interface provider 111 into script, and is able to automatically construct a connecting action between adjacent actions. Further, in the case where connecting actions are automatically constructed between adjacent actions, the message generator 112 converts the connected entire action into a script.

Text, animation information, and copyright information may be included in the message generated by the message generator 112. Further, an AID may be included in the text, and graphics (e.g., an avatar, an object, background), sound (e.g., user voice information, sounds, music, etc.), and a script (e.g., text information describing avatar and object action information, camera composition and movement, illumination position and strength, etc.) may be included in the animation information.

Further, authorship (e.g., mobile phone number, name, etc.), classification (e.g., avatar, action, object, background, camera, etc.), and license (whether or not reusing is possible, whether or not there is a fee, whether or not changes are possible, etc.) may be included in the copyright information. At this time, the message transmitting device 110 and the message receiving device 120 support the same animation functions, and in the case where the user selects an avatar action that is supported on a basic level through the user interface 210, since the actual avatar, sound, script, etc. are present also in the message receiving device 120, these parameters may be removed from the transmitted message such that the size of the message may be reduced. In addition, with respect to functions that are possessed by both the message transmitting device 110 and the message receiving device 120, it is necessary to transmit only the AID and this would be identical to sending all of the actual avatar, sound, script, etc. For this purpose, before animation information is transmitted to the message receiving device 120 from the message transmitting device 110, any one of the following may be used as a method of determining the animation functions supported by the message receiving device 120: a method of distinguishing between a common element or an added element through an AID rule, a method in which the corresponding application version of the message receiving device 120 is verified when the message receiving device 120 is able to perform bi-directional communications, and a method in which the message transmitting device 110 sends a required AID list to the message receiving device 120 and verifying the same, and after verification, transmitting information related to an AID that is not present in the message receiving device 120. However, the present invention is not limited in this respect.

The message transmitter 113 transmits the message generated by the message generator 112 to the message receiving device 120. Text and animation information, and possibly copyright information, may be included in the transmitted message.

The message receiving device 120 includes a message receiver 121 which receives the message transmitted by the message transmitting device 110, a message analyzer 122 which analyzes the received message, and a message reproducer 123 which reproduces the received message according to the analysis result to thereby display the message.

The message receiver 121 receives the message transmitted by the message transmitting device 110. Text and animation information, and possibly copyright information, may be included in the received message. Further, in the case where the animation information is animation information that is supported on a basic level by the message transmitting device 110, the animation information may include only an AID and exclude an avatar, sound, script, etc.

The message analyzer 122 analyzes the text, animation information, and copyright information included in the received message. The message reproducer 123 reproduces the text, animation information, etc. according to the analysis result. For example, from the analysis result, if “Hello” is linked to a “Greeting” action, and “Play with me” is linked to a “Rotate” action, the message reproducer 123 starts a “Greeting” action and outputs a “Hello” voice message, then starts a “Rotate” action and outputs a “Play with me” voice message. During this operation, if text is output as a voice message by the message reproducer 123, the message receiving device may support a TTS (Text-to-Speech) function, and if the message receiving device 120 does not support TTS, only the text may be displayed.

In the current embodiment of the present invention, an example is given in which the message receiving device 120 supports an animation function. However, if the message receiving device 120 does not support an animation function, the message receiving device 120 may output only the text portion of the message sent from the message transmitting device 110, or may describe the action portions of the message as a descriptive phrase, for example, as a parenthetic, such as in “(Greeting movement) Hello” and “(Twirl around motion) Play with me.”

The message relay device 130 registers and stores animation information of a predetermined user, and provides the stored animation information to a device requesting the animation information. Further, during provision of animation information, when there is a fee associated with the animation information, the message relay device 130 may receive a predetermined sum from the user of the requesting device before providing the animation information. In this case, a predetermined percentage of the sum is allocated to the user that initially registered the animation information.

The message relay device 130 includes an animation information registration unit 131, an animation information provider 132, and a fee processor 133.

The animation information registration unit 131 is able to register all the animation information of a predetermined user, and the animation information provider 132 provides corresponding animation information to a requesting user. The user registering animations in the animation information registration unit 131 may be any user that generates animation information without any relation to the users of the message transmitting device 110 and the message receiving device 120.

In the case where the animation information that is to be provided is fee-based, the fee processor 133 receives a predetermined sum from the user requesting the animation information, and allocates a predetermined percentage of the sum to the user that initially generated the animation information.

In the case where the message transmitting device 110 does not support an animation function and the message receiving device does support an animation function, the user of the message transmitting device 110 may connect to the message relay device 130 to perform transmission to the message receiving device 120 together with a pre-selected avatar. Moreover, the message relay device 130 may provide a suitable avatar to the message receiving device 120 based on the text transmitted by the message transmitting device 110, and may automatically construct the actions of the avatar and provide the same to the message receiving device 120.

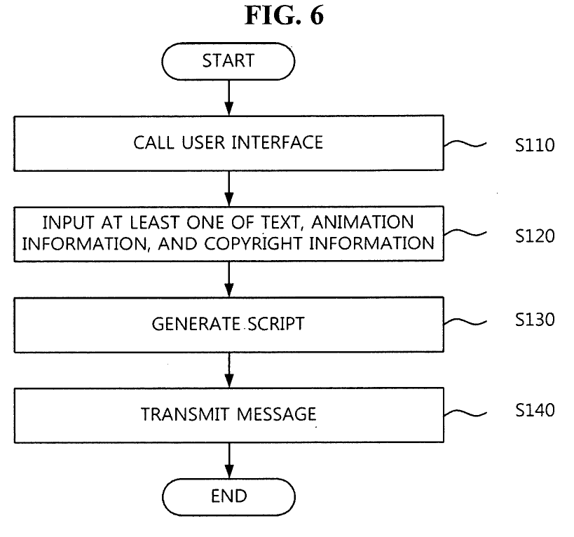

FIG. 6 is a flowchart of a method of transmitting an animation-based message according to an embodiment of the present invention.

Referring to FIG. 6, in the method of transmitting an animation-based message according to an embodiment of the present invention, the user first calls the user interface 210 provided by the message transmitting device 110 in operation S110. In the current embodiment of the present invention, since an example is described in which the message transmitting device 110 is subscribed to a service that allows for the sending and receiving of messages using animation, the message transmitting device 110 is installed with an application for this purpose, and the user interface 210 is provided by the installed application. The user selects the various modes in the first region 211 of the user interface 210 that is provided in response to the user call and inputs information of at least one of text, animation information, and copyright information in step S120. For example, the user may input through the user interface 210 text, an avatar action combination, animation information of graphics, sound, and script, and copyright information.

The message generator 112 automatically constructs a connecting action of each of the actions based on the information input through the user interface 210, and generates a script corresponding to the connected entire action in operation S130.

The message transmitter 113 transmits the generated message to the message receiving device 120 in operation S140.

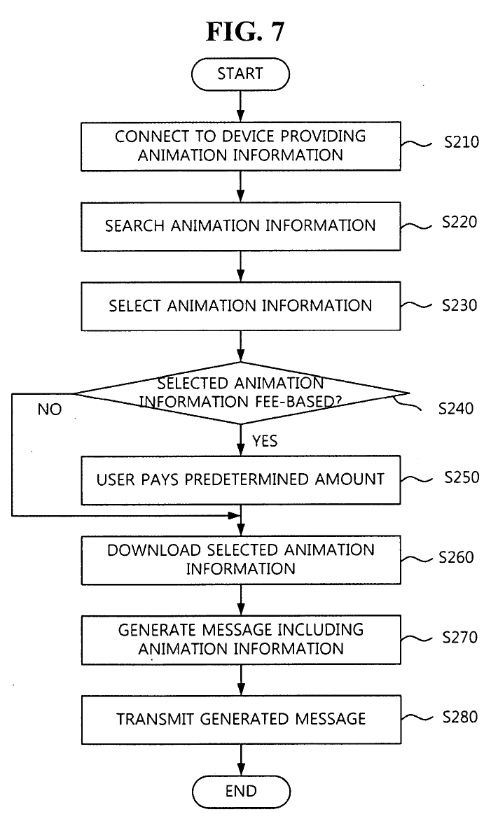

In the message transmitting method described with reference to FIG. 6, an example is described by which the user directly inputs animation information through the message transmitting device 120. However, with reference to FIG. 7, it is also possible for the user to transmit a message using animation information generated by another user.

FIG. 7 is a flowchart of a method of transmitting a message based on downloaded animation information according to an embodiment of the present invention.

With reference to FIG. 7, in the method of transmitting a message based on downloaded animation information according to an embodiment of the present invention, the user first connects to the message relay device 130 through the message transmitting device 110 in operation S210. The message relay device 130 may have various types of animation information that users have directly generated and registered.

The user searches the animation information registered in the message relay device 130 in operation S220, and selects a desired animation information in operation S230.

In the case where the user selects animation information that is fee-based in operation S240, the user pays a predetermined amount as required by the selected animation information in operation S250. The user then downloads the selected animation information in operation S260.

If the animation information is downloaded to the message transmitting device 120, a message is generated based on information input by the user and the downloaded animation information in operation S270. The generated message is then transmitted to the message receiving device 120 in operation S280.

Although a method of generating a message is not described in detail with reference to FIG. 7, this aspect of the method of FIG. 7 may be ascertained from the method described with reference to FIG. 6 since the method of FIG. 7 is identical to the method of FIG. 6 in all respects except that in the method of FIG. 6, the user directly inputs animation information.

In addition, in FIG. 7, depending on the copyright information corresponding to the downloaded animation information, the user may change the animation information. That is, the downloaded information may include copyright information for each AID, and since the determination of whether or not reproduction is permitted, changes are allowed, etc. is established according to each AID, reproduction and changes are possible depending on the copyright information as designed by the AID. This is the case when the user reuses animation information received from another user, rather than downloading animation information from the message relay device 130.

In the message transmitting methods of FIGS. 6 and 7, an example is described by which the message transmitting device 110 supports an animation service. If the message transmitting device 110 does not support an animation service, the user of the message transmitting device 110 connects to the message relay device 130 to perform transmission to the message receiving device 120 together with a pre-selected avatar. Further, the message relay device 130 may provide a suitable avatar to the message receiving device 120 based on the text transmitted by the message transmitting device 110, and may automatically construct the actions of the avatar and provide the same to the message receiving device 120.

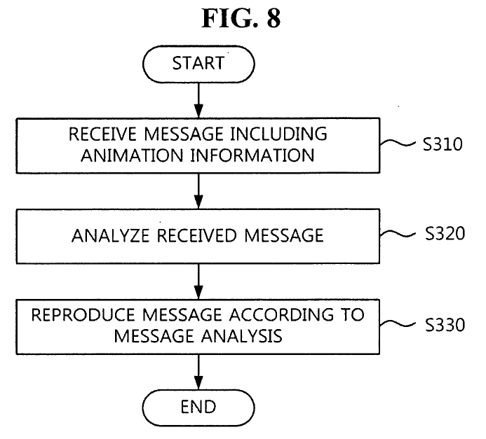

FIG. 8 is a flowchart of a method of receiving an animation-based message according to an embodiment of the present invention.

Referring to FIG. 8, in the method of receiving an animation-based message according to an embodiment of the present invention, the message receiver 121 first receives a message transmitted from the message transmitting device 110 in operation S310. The received message in this case may include text and animation information, and may also include copyright information. However, the present invention is not limited in this regard.

The message analyzer 122 analyzes the received message in operation S320, and the message reproducer 123 reproduces the text and animation information according to the analysis result. During this operation, if the message generator 113 reproduces an animation corresponding to the text, in the case where the message receiving device 120 supports TTS, the text is output as a voice message, otherwise it is output as text.

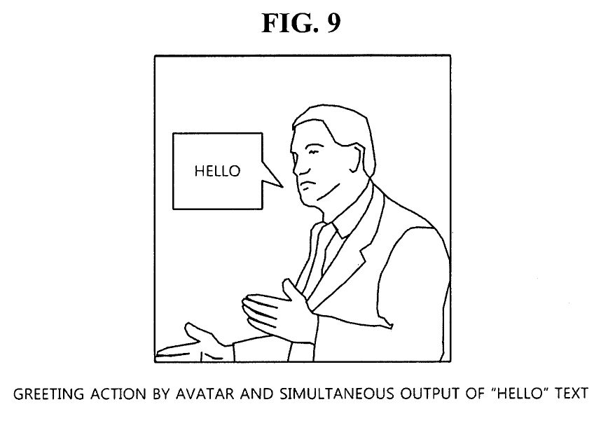

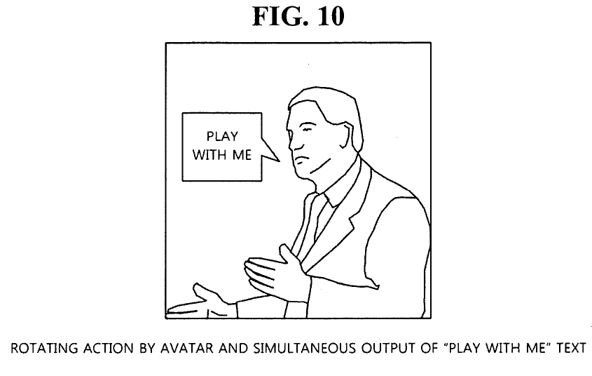

For example, in operation S310 of FIG. 8, if the text and animation information included in the received message is as shown in FIG. 4, the avatar undergoes a “Greeting” action and, at the same time, a “Hello” message is output as a voice message or text at the message receiver 120, as shown in FIG. 9. Next, with reference to FIG. 10, the avatar undergoes a “Rotate” action and, at the same time, a “Play with me” message is output as a voice message or text.

The apparatus and method for the transmission of an animation-based message of aspects of the present invention has the advantages as outlined in the following.

Since animation-based messages that have both visual and auditory aspects are used, information is transmitted more effectively than when using only text.

Further, since animation information that reflects the individual preferences of user is used, the ability to add a personal touch when sending messages is enhanced.

Additionally, animation information that is generated by users is shared and utilized, a profit model is provided to users.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in descriptive sense only and not for purposes of limitation.

What is claimed is:

1. An apparatus for transmitting an animation-based message, the apparatus comprising:
a user interface provider which provides a user interface that allows a user to input message information including script-based animation information;
a message generator which generates a message based on the input information; and
a message transmitter which transmits the generated message.

2. The apparatus of claim 1, wherein the user interface provider provides the user interface for inputting text, animation information, and copyright information.

3. The apparatus of claim 2, wherein the text includes a text message input by a user and a specific ID given to action information of an avatar corresponding to the text message.

4. The apparatus of claim 2, wherein the animation information includes graphics, sound, and a script.

5. The apparatus of claim 2, wherein the copyright information includes authorship information, classification information, and license information.

6. The apparatus of claim 2, wherein if a device that receives the message does not support an animation function, the device that receives the message outputs the animation information as a descriptive phrase.

7. An apparatus for transmitting an animation-based message, the apparatus comprising:
a message transmitting device which transmits a message including script-based animation information; and
a message relay device which provides animation information included in the message to the message transmitting device.

8. The apparatus of claim 7, wherein the message that is transmitted includes text, animation information, and copyright information.

9. The apparatus of claim 7, wherein the message relay device comprises:
an animation information registration unit which registers animation information generated by a user;
an animation information provider which provides the registered user-generated animation information to the message transmitting device; and
a fee processor which performs fee processing with respect to the provided user-generated animation information.

10. The apparatus of claim 9, wherein the provided animation information includes copyright information of the user that generated the animation information.

11. The apparatus of claim 10, wherein:
the copyright information includes whether or not it is possible to redistribute the user-generated animation information, whether or not it is possible to change the user-generated animation information, and whether or not the user-generated animation information is fee-based; and
if the user-generated animation information is fee-based, the fee processor performs fee processing with respect to the provided user-generated animation information.

12. The apparatus of claim 7, wherein if the message transmitting device does not support an animation function, the message relay device automatically constructs an avatar or animation information based on text of the message transmitted by the message transmitting device, and transmits the message to a device receiving the message.

13. A method of transmitting an animation-based message, the method comprising:
providing a user interface that allows a user to input message information including script-based animation information;
generating a message based on the input information; and
transmitting the generated message.

14. The method of claim 13, wherein when providing the user interface, the user interface is provided for inputting text, animation information, and copyright information.

15. The method of claim 14, wherein the text includes a text message input by a user and a specific ID given to action information of an avatar corresponding to the text message.

16. The method of claim 14, wherein the animation information includes graphics, sound, and a script.

17. The method of claim 14, wherein the copyright information includes authorship information, classification information, and license information.

18. The method of claim 14, further comprising outputting the animation information as a descriptive phrase by a device that receives the message if the device that receives the message does not support an animation function.

19. A method of transmitting an animation-based message, the method comprising:
transmitting a message including script-based animation information; and
providing animation information included in the message to a device transmitting the message.

20. The method of claim 19, wherein the message that is transmitted includes text, animation information, and copyright information.

21. The method of claim 19, wherein the providing of the animation information comprises:
registering animation information generated by a user;
providing the registered user-generated animation information to the device transmitting the message; and
performing fee processing with respect to the provided user-generated animation information.

22. The method of claim 21, wherein the provided animation information includes copyright information of the user that generated the animation information.

23. The method of claim 22, wherein:
the copyright information includes whether or not it is possible to redistribute the user-generated animation information, whether or not it is possible to change the user-generated animation information, and whether or not the user-generated animation information is fee-based; and
when performing the fee processing, if the user-generated animation information is fee-based, fee processing is performed with respect to the provided user-generated animation information.

24. The method of claim 19, wherein when providing the animation information, if the device transmitting the message does not support an animation function, an avatar or animation information is automatically constructed based on text of the message transmitted by the device transmitting the message, and the message is transmitted to a device receiving the message.
